(19) United States
(12) Patent Application Publication
(10) Pub. No.: US 2008/0079726 A1
(43) Pub. Date: Apr. 3, 2008

(54) Visual display of process sequences

(76) Inventor: Wolfgang Geiger, Lehrberg (DE)

Correspondence Address: Siemens Corporation;Intellectual Property Department, 170 Wood Avenue South, Iselin, NJ, 08830, US

(21) Appl. No.: 11/825,071

(22) Filed: Jul. 3, 2007

Related U.S. Application Data
(60) Provisional application No. 60/818,415, filed on Jul. 3, 2006.

(51) Int. Cl. G06T 11/20

(52) U.S. Cl. 345/440

(57) ABSTRACT

The aim is to make it easier to compare industrial or clinical processes. To this end provision is made for the processes to be systematically divided into prescribed process steps. The process steps are also divided into prescribed sub-process steps. Each of the processes is then shown in a respective graphic with the process steps in a first dimension and with the sub-process steps in a second dimension, so that each sub-process step has a distinct two-dimensional location in the respective graphic, with each sub-process step being graphically marked if the respective process contains it. The graphical presentation can now be used to compare the processes easily and clearly.

### CROSS REFERENCE TO RELATED APPLICATIONS

The present application claims the benefit of the provisional patent application filed on Jul. 3, 2006, and assigned application No. 60/818,415 which is incorporated by reference herein in its entirety.

### FIELD OF THE INVENTION

The present invention relates to a method for comparing at least two industrial or clinical processes.

### BACKGROUND OF THE INVENTION

To assess process sequences, they are often graphically displayed. To display them, software programs are used which serve primarily to reproduce the process steps in the form of flowcharts. These then clearly show the input and output of the displayed process or of the process steps. This type of display is generally unsuitable for comparing individual process steps, however. It is also difficult to interpret the processes using this presentation.

### SUMMARY OF THE INVENTION

It is therefore the object of the present invention to propose a method which can easily be used to compare various processes with one another.

The invention achieves this object by means of a method for comparing at least two industrial or clinical processes by systematically dividing the at least two processes into prescribed process steps, systematically dividing the process steps into prescribed sub-process steps, showing each of the at least two processes in a respective graphic with the process steps in a first dimension and with the sub-process steps in a second dimension, so that each sub-process step has a distinct two-dimensional location in the respective graphic, with each sub-process step being graphically marked if the respective process contains it, and comparing the at least two processes using the associated graphics.

The inventive graphical display means that the individual processes are provided with graphical patterns which are characteristic in the same way as a fingerprint. In addition, the resultant graphics or patterns for the various processes can easily be compared with one another, since the structure of the graphic is standard as a result of the process steps and sub-process steps being prescribed.

In line with one development of the inventive method, the process steps in each graphic can be graphically grouped into process sections. This allows the graphical dimension of the process steps to have additional criteria added to it which would correspond to a further dimension.

In the same way, the sub-process steps in each graphic can be graphically grouped into sub-process sections. This division can also be used to add more or less a further dimension without leaving the two-dimensionality of the graphic.

Preferably, all sub-processes which are common to all processes are graphically marked accordingly. This allows commonalities for a plurality of processes to be identified at one glance. In particular, it is beneficial to make the graphical marking by specific shaping or coloration or defined signals.

The at least two processes which are to be compared may be production processes and/or clinical sequences. In principle, the inventive comparison method can be used for any desired type of processes. In particular, the method is suitable for clinical sequences for manufacturing or adjusting hearing aids, however.

### BRIEF DESCRIPTION OF THE DRAWINGS

The present invention is now explained in more detail with reference to the appended drawings, in which:

FIG. 1 shows a process pattern for an inventive exemplary embodiment, where a dimension represents a process level 2;

FIG. 2 shows a detail from FIG. 1 to show process level 3 and process level 4, and

FIG. 3 shows process patterns for a plurality of clinics.

### DETAILED DESCRIPTION OF THE INVENTION

The exemplary embodiment outlined in more detail below is a preferred embodiment of the present invention.

Processes need to be able to be compared using graphical tools. It is therefore proposed that processes in the field of industry, clinics or administration be visually displayed by a process pattern or a process “fingerprint”.

The text below gives a more detailed explanation of a process comparison for sequences in clinics. To this end, the workflow in a clinic is first of all systematically divided into individual processes at the highest level (Level 0). A Level 0 process of this kind is hearing-aid supply, for example. This Level 0 process is subdivided into subordinate Level 1 processes. A subordinate process of this kind would be hearing-aid supply for adults, for example.

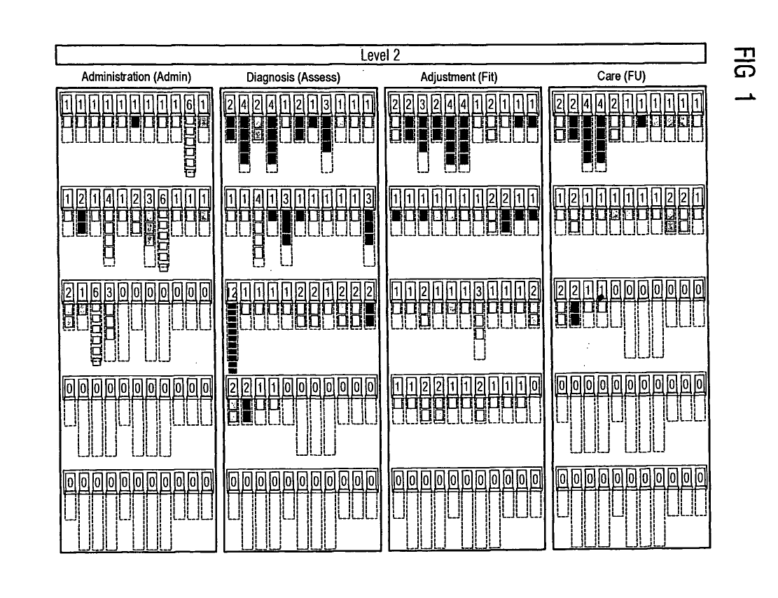

An entire subordinate Level 1 process is shown by way of example in FIG. 1. This subordinate process can in turn be subdivided into sub-processes on a subordinate level (Level 2). In this case, these sub-processes are: administration (Admin), diagnosis (Assess), adjustment (Fit) and care (FU). The Level 2 sub-processes are shown horizontally next to one another here.

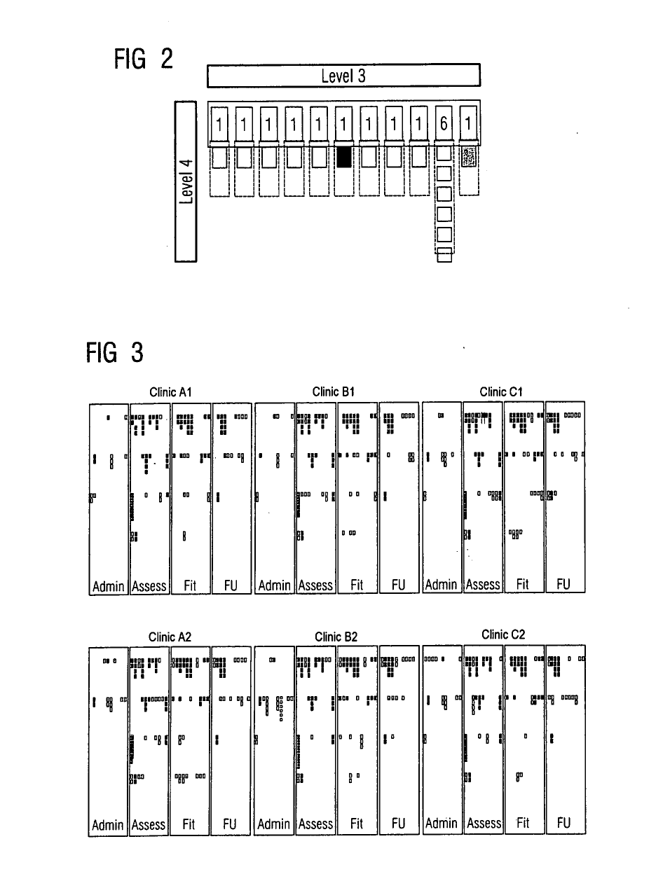

FIG. 2 is based on the top left-hand pattern from FIG. 1. This pattern shows eleven Level 3 process steps horizontally next to one another for the Level 2 sub-process of administration. A process step of this kind would be selection of the audiology department, sending an appropriate letter to the audiology department, etc. In the case of the “adjustment” sub-process, a Level 3 sub-process step would be taking an impression of the ear, for example.

Some of the individual process steps can again be subdivided into sub-process steps. These sub-process steps are associated with an even more subordinate level—Level 4. For each of the Level 3 process steps, the example in FIG. 2 indicates how many Level 4 sub-process steps there are. In addition, the individual sub-process steps have different colors. This makes it possible to distinguish which of the sub-process steps is executed in each of the processes which are to be compared, for example.

FIG. 3 shows a respective process pattern in line with that in FIG. 1 for six different clinics, A1, B1, C1, A2, B2, C2. This allows a comparison between the hearing-aid supply for adults (Level 1 process) in various clinics, for example. For the individual clinics it is immediately possible to tell which sub-processes, process steps and sub-process steps are actually carried out and which sub-process steps are currently being carried out in all clinics.

To create such graphics, the data captured from the clinics or industrial processes can be put into tabular form using a spreadsheet program, for example. Having been read into a pattern visualization tool, the data can then be displayed as shown in FIG. 3.

The patterns shown in FIG. 3 can be used for analysis within a unit (in this case a clinic, for example). This means that each process, each subordinate process, each sub-process, etc. can be analyzed individually. This also involves reproducing information regarding quantitative variables in the graphic. Examples of quantitative variables of this kind would be time, cost, personnel involvement, etc. The quantitative values can be distinguished by the size or color of the patterns or their intensity. By way of example, the size of a box representing a sub-process step can thus be used to symbolize how much this sub-process step costs.

In addition, it is also possible to show qualitative statements using the graphic. By way of example, it is thus possible to indicate who is involved in the respective process or process step, which IT systems are being used etc. This allows statements to be made about changes of personnel or parallel uses etc. Specifically, it is possible to indicate all processes for which a telephone, a particular piece of software or personnel with a particular level of training is used, for example.

Alternatively, the inventive graphic can be used to perform an analysis between a plurality of clinics, as has already been indicated by FIG. 3 and the explanation thereof. In this context, it is possible to compare process sequences and individual process steps from various departments or sequences. Similarly, it is also possible to use quantitative displays here, for example in order to compare cost, time, personnel involvement etc. Likewise, qualitative displays may also be useful here for obtaining statements regarding people, capacities, infrastructure, devices etc.

1. A method for comparing at least two processes, comprising:
systematically dividing each of the at least two processes into a plurality of prescribed process steps;
systematically dividing the process steps into a plurality of prescribed sub-process steps;
graphing the at least two processes in respective graphics by placing the process steps in a first dimension and the sub-process steps in a second dimension so that the sub-process steps are two-dimensionally distinctly located in the graphics; and
comparing the at least two processes using the graphics.

2. The method as claimed in claim 1, wherein the sub-process steps are graphically marked in the graphics if the processes comprise the sub-process steps.

3. The method as claimed in claim 1, wherein the process steps in the graphics are graphically grouped into process sections.

4. The method as claimed in claim 1, wherein the sub-process steps in the graphics are graphically grouped into sub-process sections.

5. The method as claimed in claim 1, wherein common sub-processes that are common to the processes are graphically marked in the graphics.

6. The method as claimed in claim 5, wherein the common sub-processes are marked by a specific shape, signal, or color.

7. The method as claimed in claim 1, wherein the processes are industrial or clinical processes.

8. The method as claimed in claim 7, wherein the clinical processes are used for manufacturing or adjusting a hearing aid.

9. A computer program loadable to a computer for comparing at least two processes, wherein the computer program is configured to:
systematically divide each of the at least two processes into a plurality of prescribed process steps,
systematically divide the process steps into a plurality of prescribed sub-process steps,
graph the at least two processes in respective graphics by placing the process steps in a first dimension and the sub-process steps in a second dimension so that the sub-process steps are two-dimensionally distinctly located in the graphics.

10. The computer program as claimed in claim 9, wherein the sub-process steps are graphically marked in the graphics if the processes comprise the sub-process steps.

11. The computer program as claimed in claim 9, wherein the process steps in the graphics are graphically grouped into process sections.

12. The computer program as claimed in claim 9, wherein the sub-process steps in the graphics are graphically grouped into sub-process sections.

13. The computer program as claimed in claim 9, wherein common sub-processes that are common to the processes are graphically marked in the graphics.

14. The computer program as claimed in claim 9, wherein the processes are industrial or clinical processes.

15. A computer for comparing at least two processes, comprising:
a hardware that:
systematically divides each of the at least two processes into a plurality of prescribed process steps,
systematically divides the process steps into a plurality of prescribed sub-process steps,
graphs the at least two processes in respective graphics by placing the process steps in a first dimension and the sub-process steps in a second dimension so that the sub-process steps are two-dimensionally distinctly located in the graphics; and
a display device that displays the graphics for comparing the at least two processes.

16. The computer as claimed in claim 15, wherein the sub-process steps are graphically marked in the graphics if the processes comprise the sub-process steps.

17. The computer as claimed in claim 15, wherein the process steps in the graphics are graphically grouped into process sections.

18. The computer as claimed in claim 15, wherein the sub-process steps in the graphics are graphically grouped into sub-process sections.

19. The computer as claimed in claim 15, wherein common sub-processes that are common to the processes are graphically marked in the graphics.

20. The computer as claimed in claim 15, wherein the processes are industrial or clinical processes.
